(19) United States
(12) Patent Application Publication
(10) Pub. No.: US 2006/0130357 A1
(43) Pub. Date: Jun. 22, 2006

(54) Continuous horizontal grain drying system

(75) Inventor: Richard L. Long JR., Osceola, IA (US)

Correspondence Address: MCKEE, VOORHEES & SEASE, P.L.C., 801 GRAND AVENUE, SUITE 3200, DES MOINES, IA, 50309-2721, US

(73) Assignee: Cemen Tech Inc., Indianola, IA (US)

(21) Appl. No.: 11/014,926

(22) Filed: Dec. 17, 2004

(51) Int. Cl. F26B 7/00; F26B 3/00

(52) U.S. Cl. 34/389; 34/503; 34/504

(57) ABSTRACT

A grain dryer is provided with a housing, and a hot air source connected to the housing so as to dry grain in the housing. A rehydration source is connected to the housing to add moisture, in the form of steam or hot water, to grain which is over-dried. A conveyor moves the grain through the housing during the drying and rehydration processes.

### BACKGROUND OF THE INVENTION

Three general types of grain drying systems are known in the art. The first system is a batch operation which dries a fixed quantity or volume of grain in a single batch in a dryer, and then discharges the dried grain batch before introducing a new batch of grain for drying. A second type of grain dryer is a vertical or gravity feed dryer, wherein the grain flows downwardly through a housing while being exposed to hot air so as to dry the grain. The third type of dryer is a horizontal dryer, wherein the grain is carried by a conveyor through a housing and dried therein by the application of hot air. Each system has certain benefits over the other systems.

One problem associated with all three systems is over-drying of the grain. Normally, it is desirable to maintain a certain moisture level in the grain, depending upon the type of grain, for both storage and selling purposes. For example, an optimal percentage moisture for soybean is 13% by weight per bushel. If the grain resides in the dryer too long, or the dryer is too hot, the grain will become too dry. Also grain may be too dry coming in from the field.

Accordingly, a primary objective of the present invention is the provision of a grain dryer having the ability to rehydrate grain which has been over-dried or is too dry coming in from the field.

Another objective of the present invention is the provision of a grain dryer which can selectively supply steam or hot water to the grain so as to control the moisture content of the dried grain.

Another objective of the present invention is the provision of a method of drying grain which includes rehydration of the grain if the dryness drops below a preset value.

Still another objective of the present invention is the provision of an improved horizontal grain dryer.

A further objective of the present invention is the provision of a portable grain dryer.

These and other objectives become apparent from the following description of the invention.

### BRIEF SUMMARY OF THE INVENTION

A grain dryer is provided with a housing, with a source of hot air operatively connected to the housing to dry grain within the housing. In a preferred embodiment, the grain is continuously moved through the housing on a conveyor. The dryer includes a rehydration source operatively connected to the housing to add moisture to over-dried grain.

The grain drying method comprises moving grain into the housing, introducing hot air into the housing to dry the grain, measuring the moisture content of the dried grain, and adding moisture to the dried grain if the measured moisture content is less than a predetermined value. The measured moisture is fed back into a PLC control system, which in turn controls heat and grain flow in the dryer. The grain is then discharged from the housing. The method may also include the application of a treatment, such as an insecticide or fungicide, to the grain within the housing prior to discharge.

### BRIEF DESCRIPTION OF THE DRAWINGS

FIG. 1 is a schematic view showing one embodiment of the grain dryer of the present invention having a belt conveyor.

FIG. 2 is a schematic view showing how a grain dryer similar to that shown in FIG. 1 is easily mounted on a flatbed truck so as to be portable.

FIG. 3 is a schematic view showing another embodiment of a grain dryer of the present invention having a conveyor auger.

### DETAILED DESCRIPTION OF THE PREFERRED EMBODIMENT

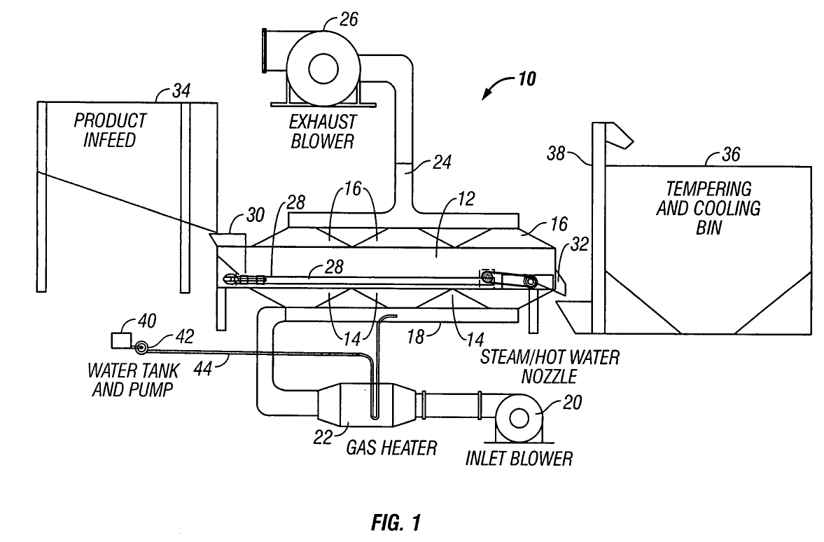

The grain drying system of the present invention is generally designated in the drawings by the reference numeral 10. The dryer 10 generally includes a housing 12 with air inlet plenums 14 and air outlet or exhaust plenums 16. In FIG. 1, the inlet plenums 14 are shown to be on the bottom of the housing 12, while the outlet plenums 16 are shown to be on the top of the housing 12. It is understood that the arrangement of these plenums may be modified or reversed without departing from the scope of the present invention. Also, the number of inlet and outlet plenums may be varied, with one or more inlet and outlet plenums. An air inlet duct or line 18 extends from a blower or fan 20, through a heater 22 and is connected to the inlet plenums 14. An air outlet duct 24 extends from the outlet plenums 16 and includes an exhaust blower or fan 26. One or both of the blowers 20, 26 may be used. A negative pressure is preferably maintained in the housing 12.

In a preferred embodiment of the invention, the dryer 10 is horizontal and a belt conveyor 28 extends substantially along the length of the housing 12. Preferably, the belt is perforated. The belt conveyor 28 is adapted to carry grain through the housing for drying by the hot air. The housing 12 includes a product inlet chute 30 at one end and a product discharge chute 32 at the other end. The chute 30 is connected to an adjustable product slide gate, which is controlled manually or via a PLC so as to set and maintain grain bed depth inside the dryer. A product feed hopper 34 is provided adjacent the inlet chute 30. A receiving bin or hopper 36 is provided adjacent the discharge chute 32. As shown in FIG. 1, a conveyor 38 resides between the discharge chute 32 and the receiving bin 36 so as to carry dried grain from the housing 12 to the receiving bin 36.

The dryer 10 also includes a rehydration system which is used in the event that the grain becomes over-dried. More particularly, the rehydration system includes a water tank 40 and a pump 42 connected to a water supply line 44. The water supply line 44 terminates in or adjacent to the air inlet plenums 14 so as to supply steam or hot water to the grain within the housing 12. Preferably, the water supply line 44 includes one or more spray nozzles for applying the steam or hot water to the grain. Also, the spray nozzles are preferably located in the downstream path of the housing 12. Sensors (not shown) are provided in the housing to determine the moisture content of the grain. If the moisture content falls below a pre-set value, the pump 42 is actuated so as to apply steam or hot water to the over-dried grain.

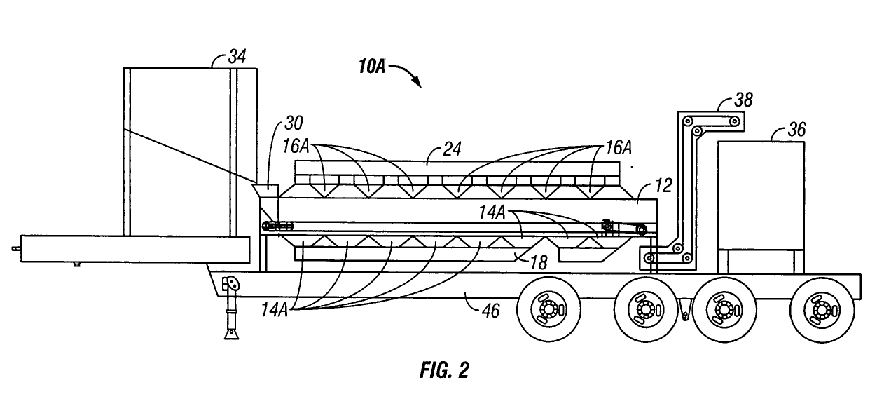

FIG. 2 shows a dryer 10A similar to that shown in FIG. 1. The dryer 10A shows an increased number of smaller air inlet plenums 14A and air outlet plenums 16A. The dryer 10A is mounted on a flatbed trailer 46, so as to be portable. The dryer 10A functions similarly to the dryer 10, described above.

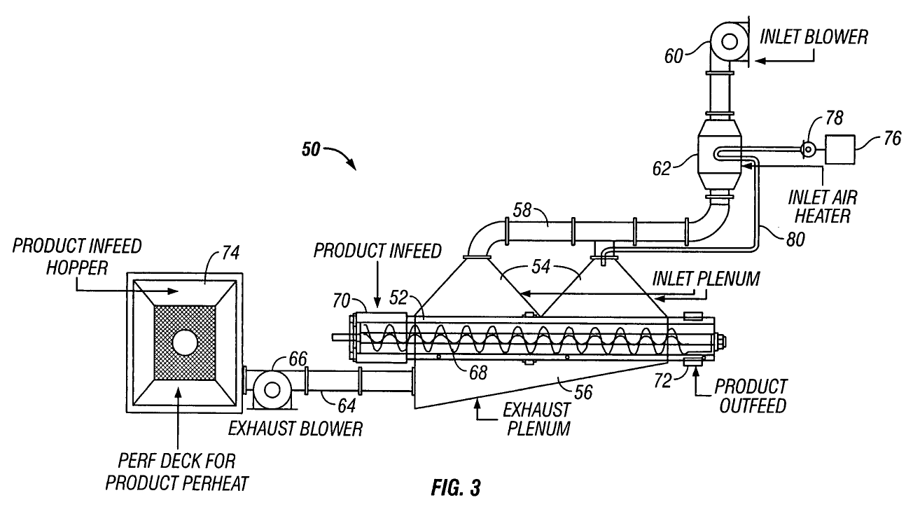

FIG. 3 shows an alternative embodiment of a dryer 50. The dryer 50 includes a housing 52 with an air inlet plenum 54 and an air outlet or exhaust plenum 56. An air inlet duct 58 extends between a blower 60 and the inlet plenums 54, with a heater 62 disposed in the duct 58. An air outlet duct 64 extends from the exhaust plenum 56 to direct air from the housing 52. An exhaust blower 66 facilitates the drawing of air from the housing 52.

The housing 52 includes an auger conveyor 68 extending therethrough. A grain inlet chute 70 is provided at one end of the housing 62, with a grain outlet chute 72 being located at the opposite end of the housing 52.

A grain feed hopper 74 directs product into the inlet chute 70 for passage through the housing 52. As shown in FIG. 3, as an option, the air outlet duct 64 may direct air into the feed hopper 74 so as to preheat the grain.

A grain receiving bin similar to that described with respect to FIG. 1 is provided adjacent the grain outlet chute, but is not shown in FIG. 3.

The dryer 50 also includes the rehydration system, similar to the dryer 10. More particularly, the rehydration system for the dryer 50 includes a water tank 76, a pump 78, and a supply line 80. The supply line 80 extends into the heater 62 of the dryer 50. The supply line 80 terminates in or adjacent to the air inlet plenum 54, preferably in the downstream half of the dryer 50. One or more spray nozzles may be provided on the terminal end of the supply line 80 so as to apply steam or hot water to over-dried grain carried by the auger conveyor 68. One or more sensors are provided in the housing 52 to detect the moisture content of the grain. Preferably, the sensors are located at least at the midpoint of the housing 52, but may be located elsewhere along the length of the housing 52.

The grain drying method of the present invention includes the steps of moving the grain into the housing 12, 52 and supplying heated drying air via the air inlet duct 24, 64 and the inlet plenums 14, 54. The hot air passes through the grain so as to dry the grain. The moisture content, or dryness of the grain is measured with the sensors, at least at the midpoint of the housing 12, 52. If the moisture content is below a predetermined, desirable value, the pump 42, 78 is actuated to supply steam or hot water to the over-dried grain within the housing 12, 52. The grain is then discharged via the discharge chute 32, 72.

In the preferred embodiment, the dryers 10, 50 are continuous horizontal dryers. It is understood that the rehydration system of the present invention can also be utilized on batch dryers or gravity dryers, so as to rehydrate over-dried grain. In each embodiment, insecticide, pesticide and/or fungicide treatment may be applied to the grain in the dryer, such as by fumigation.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A continuous grain drying and moisturizing system, comprising:
a conveyor having a grain inlet and a grain outlet;
an air inlet plenum and an air outlet plenum positioned on opposite sides of the conveyor;
a first blower to move air through the air inlet and outlet plenums and through grain carried by the conveyor to dry the grain; and
a nozzle positioned above the conveyor to apply moisture for rehydrating the grain.

2. The system of claim 1 wherein the air inlet plenum is below the conveyor and the air outlet plenum is above the conveyor.

3. The system of claim 1 wherein the air inlet plenum is above the conveyor and the air outlet plenum is below the conveyor.

4. The system of claim 1 wherein the conveyor is an endless belt.

5. The system of claim 4 wherein the belt is perforated.

6. The system of claim 1 wherein the conveyor is an auger.

7. The system of claim 1 wherein the blower is located in the air inlet plenum.

8. The system of claim 1 wherein the blower is located in the air outlet plenum.

9. The system of claim 1 wherein the conveyor is enclosed in a housing and the blower maintains a negative pressure in the housing.

10. The system of claim 1 wherein the first blower is in one of the plenums and further comprising a second blower in the other of the plenums.

11. The system of claim 1 further comprising a heater to heat the air before contacting the grain.

12. A continuous grain drying method, comprising:
transporting the grain with a conveyor from an inlet end to an outlet end;
passing heated air through the moving grain to dry the grain;
measuring dryness of the grain as the grain is transported; and
rehydrating the grain if the dryness is below a preset value.

13. The method of claim 13 wherein the conveyor is enclosed in a housing, and the method further comprising maintaining a vacuum within the housing.

14. The method of claim 13 further comprising blowing air into the housing and drawing air from the housing.

15. The method of claim 13 wherein the rehydration step is accomplished by injecting steam into the housing for absorption by the grain.

16. The method of claim 12 wherein the rehydrating step is accomplished by spraying water onto the grain.

17. The method of claim 12 wherein the conveyor is a perforated belt and the air passes upwardly to the belt and the grain.

18. The method of claim 12 wherein the air passes upwardly through the grain.

19. The method of claim 12 wherein the air passes downwardly through the grain.

20. The method of claim 12 further comprising applying an additional treatment to the grain.

21. The method of claim 18 wherein the treatment is an insecticide.

22. The method of claim 18 wherein the treatment is a fungicide.

23. A grain dryer, comprising:
a housing;
a hot air source operatively connected to the housing to dry grain in the housing; and
a rehydration source operatively connected to the housing to add moisture to over-dried grain.

24. The grain dryer of claim 23 further comprising a conveyor extending through the housing.

25. A grain drying method, comprising:
moving grain into a housing;
introducing hot air into the housing to dry grain;
measuring the moisture content of the dried grain;
adding moisture to the dried grain if the measured moisture content is less than a predetermined value; and
discharging the grain from the housing.

26. The grain drying method of claim 25 further comprising moving the grain continuously through the housing.

27. The grain drying method of claim 25 further comprising applying a treatment to the grain within the housing.

28. The grain drying method of claim 27 wherein the treatment is selected from a group comprising insecticide, pesticide, and fungicide.

29. The grain drying method of claim 27 wherein the treatment is fumigation.
